(19) United States
(12) Patent Application Publication
(10) Pub. No.: US 2026/0229416 A1
(43) Pub. Date: Aug. 6, 2026

(54) A POLYMER CAPACITOR COMPRISING A SOLUTION-PROCESSED N-TYPE CONDUCTING POLYMER

(71) Applicant: WESTRA MATERIALS AB, Norrköping (SE)

(72) Inventors: Qifan Li, Norrköping (SE); Jun-Da Huang, Norrköping (SE); Chi-Yuan Yang, Norrköping (SE); Simone Fabiano, Norrköping (SE); Marc-Antoine Stoeckel, Norrköping (SE)

(73) Assignee: WESTRA MATERIALS AB, Norrköping (SE)

(21) Appl. No.: 19/149,286

(22) PCT Filed: Feb. 9, 2024
(86) PCT No.: PCT/EP2024/053317

§ 371 Date: Jul. 18, 2025

(30) Foreign Application Priority Data
Feb. 10, 2023 (WO) PCT/EP2023/053385
Feb. 10, 2023 (WO) PCT/EP2023/053391
May 17, 2023 (WO) PCT/EP2023/063322

(51) Int. Cl. H01G 9/028; H01G 9/00; H01G 9/04; H01G 9/042; H01G 9/048; H01G 9/07; H01G 9/08; H01G 9/15

(52) U.S. Cl. CPC H01G 9/028; H01G 9/0036; H01G 9/0425; H01G 9/048; H01G 9/07; H01G 9/08; H01G 9/15; H01G 2009/05

(57) ABSTRACT

The present invention relates to a polymer capacitor comprising an anode, a dielectric layer and a cathode, wherein said cathode comprises a solution-processed n-type conducting polymer having conductivity of at least 100 S/cm, preferably at least 500 S/cm.

### TECHNICAL FIELD

The present invention relates to a polymer capacitor comprising a solution-processed n-type conducting polymer, and a method for manufacturing a water-based n-type conducting polymer for use in such a device.

### BACKGROUND OF THE INVENTION

Water-based conducting polymer inks have broad industrial applications, such as antistatic coatings, polymer capacitors, organic solar cells, displays (LCD/OLED), and printed electronics. PEDOT:PSS is a commercially available p-type (hole-transporting) water-based conducting polymer ink with a pristine electrical conductivity >1 S cm⁻¹, reaching values >4000 S cm⁻¹ after secondary doping or post-treating. However, water-based n-type (electron-transporting) conducting polymers are crucial when considering complementary components in semiconducting devices and circuitry.

The BBL:PEI ethanol-based inks reported in WO 2022/106017 and WO 2022/106018 are the first step towards environmentally friendly solvent n-type inks. However, there are several problems partially limiting their application. First of all, ethanol has strict requirements for fire prevention during production, transportation, storage, and usage. Further, the inks disclosed in the above-referenced applications are mainly limited to deposition methods such as spray-casting, spin-casting and the like due to the large particle size. As may be gleaned from the above-cited references, the highest electrical conductivity of BBL:PEI inks is below 10 S cm⁻¹, which make them unsuitable for devices sensitive to sheet resistance.

Recently, Fei Huang et al. reported a solution-processed n-type conducting polymer poly(benzodifurandione) (PBFDO) with electrical conductivity over 2000 S/cm (Nature, 2022, s41586-022-05295-8).

Developing a water-based n-type CP ink with high conductivity, processability, and stability equivalent to PEDOT:PSS remains a challenging scientific and industrial endeavour with widespread impact in cost-efficient printed organic electronics.

A polymer capacitor is an electrolytic capacitor (e-cap) with a solid conductive polymer electrolyte. There are four different types: polymer tantalum electrolytic capacitor (Polymer Ta-e-cap), polymer aluminium electrolytic capacitor (Polymer Al-e-cap), hybrid polymer capacitor (Hybrid polymer Al-e-cap), and Polymer niobium oxide electrolytic capacitors.

Polymer Ta-e-caps are available in rectangular surface-mounted device (SMD) chip style. Polymer Al-e-caps and hybrid polymer Al-e-caps are available in rectangular surface-mounted device (SMD) chip style, in cylindrical SMDs (V-chips) style or as radial leaded versions (single-ended).

Polymer capacitors are characterized by particularly low internal equivalent series resistances (ESR) and high ripple current ratings. Their electrical parameters have similar temperature dependence, reliability and service life compared to solid tantalum capacitors, but have a much better temperature dependence and a considerably longer service life than aluminium electrolytic capacitors with non-solid electrolytes. In general polymer e-caps have a higher leakage current rating than the other solid or non-solid electrolytic capacitors.

Polymer capacitors are also available in a hybrid construction. The hybrid polymer aluminium electrolytic capacitors combine a solid polymer electrolyte with a liquid electrolyte. These types are characterized by low ESR values but have low leakage currents and are insensitive to transients, however they have a temperature-dependent service life similar to non-solid e-caps.

Polymer capacitors are mainly used in power supplies of integrated electronic circuits as buffer, bypass and decoupling capacitors, especially in devices with flat or compact design. Thus they compete with Multilayer Ceramic Capacitor (MLCC) capacitors, but offer higher capacitance values than MLCC, and they display no microphonic effect (such as class 2 and 3 ceramic capacitors).

The most important electrical property of an electrolyte in an electrolytic capacitor is its electrical conductivity. The electrolyte forms the counter electrode, of the e-cap, the cathode. The benefits provided by a solid polymer electrolyte are the significantly lower ESR of the capacitor and the low temperature dependence of the electrical parameters.

Currently available polymer electrolytes are made of precursors consisting of very small base materials that can penetrate even the smallest pores. The size of this precursors is the limiting factor in the size of the pores in the etched aluminium anode foils or of the size of tantalum powder. The rate of polymerization must be controlled for capacitor manufacturing. Too rapid polymerization does not lead to a complete anode coverage, while too slow polymerization increases production costs. Neither the precursors nor the polymer or its residues may attack the anodes oxide chemically or mechanically. The polymer electrolyte must have high stability over a wide temperature range over long times. Currently available polymer e-caps employ either polypyrrole (PPy) or polythiophene (PEDOT). However, capacitors comprising these polymers suffer from the disadvantage of poor thermal stability. The daily use temperature of supercapacitors used in areas such as autonomous driving can be above 170° C. The conductivity of conventional conducting polymers drops at such temperatures, even in encapsulation without air.

Therefore, there is a need for polymer capacitors comprising a solution-processed, preferably water-based n-type CP ink with high conductivity, processability, and stability.

### SUMMARY OF THE INVENTION

Considering the above, the present invention aims to solve the problems of the prior art. To this end, the present invention relates to a polymer capacitor comprising an anode, a dielectric layer and a cathode, wherein said cathode comprises a solution-processed n-type conducting polymer having conductivity of at least 100 S/cm, preferably at least 500 S/cm.

The solution-processed n-type conducting polymer may further have a work function of at least 4.7 eV, preferably at least 4.9 eV. Further, the solution-processed n-type conducting polymer may be side-chain free. The term “side-chain free” is in the context of the present invention intended to mean that only one carbon atom is extending from the conjugated backbone system of the polymer. Such an embodiment offers the advantage of an improved interface to the nanoparticles of the active material and/or surfaces of the electron collector, since side chains introduce some distance between the TT-system of the polymer and the surface of the electron collector, which in turn can decrease the charge transfer. Further, the solution-processed n-type conducting polymer may comprise a repeating unit comprising a central symmetrical benzene ring as the skeleton, active hydrogen and at least one electron-withdrawing group at the benzylic position. In particular, the solution-processed n-type conducting polymer may be poly(benzodifurandione) (PBFDO), poly[(2,2′-(2,5-dihydroxy-1,4-phenylene)diacetic acid)-co-3,7-dihydrobenzo[1,2-b:4,5-b′]difuran-2,6-dione] (PDADF), poly[(2,2′-(2,5-dihydroxy-1,4-phenylene)diacetic acid) (PDADF-P) or a mixture thereof, as depicted below. The structure of PDADF-P is similar to the structure of PDADF, but lack heterocyclic segments.

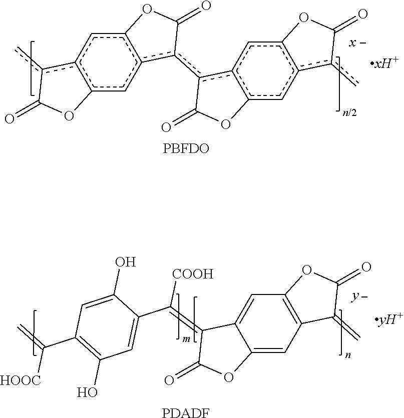

The n-type conducting polymer used in the polymer capacitor of the present invention may be manufactured by the method comprising the steps of:
1) adding a monomer to a solvent system comprising a polar aprotic solvent and an oxidizing agent in the presence of a catalyst, thus providing a reaction solution;
2) allowing the monomer to polymerize in the reaction solution thus obtaining an ink comprising n-type conducting polymer.

The catalyst is a quinone or a quinone precursor, and comprises at least one branched side chain. By the term “quinone precursor” is understood a species that is able to form a quinone structure. The side chain may comprise from 3 to 100 carbon atoms. The side chain may further comprise at least one functional group, e.g. a hydroxyl group. Further, the side chain may further comprise a branch centre. Further, the side chain may comprise at least one chiral centre. It has been shown that the catalyst according to such a method does not crystallize during the polymerisation reaction, since the at least one branched side chain prevents such a crystallization. Since the catalyst does not crystallize, it must not be removed from the ink and a dialysis step as described in WO2022262159 is eliminated.

Thus, one of the advantages of the method mentioned above is that dialysis step in order to remove the catalyst is eliminated, since the catalyst according to the method above does not crystallize due to the presence of at least one branched side chain. A branch side chain that is long enough will not crystallize, and a branched side chain with 3-4 carbon atoms will crystallize.

The monomer has the central symmetrical benzene ring as the skeleton, active hydrogen and at least one electron-withdrawing group at the benzylic position. The electron-withdrawing groups may be carbonyl, carboxyl, amide, alkoxy acyl or the like.

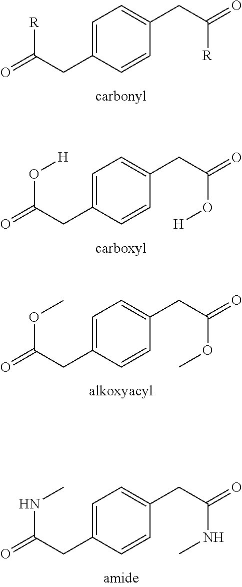

Further, the monomer may be in the form of a heterocyclic moiety having a central symmetrical benzene ring fused with at least one, preferably at least two rings, preferably five-membered rings. The monomer further comprises an active hydrogen and at least one electron-withdrawing group at the benzylic position. In particular, the monomer may be 3,7-dihydrobenzo[1,2-b:4,5-b′]difuran-2,6-dione (HBFDO), 5,7-dihydropyrrolo[2,3-f]indole-2,6(1H,3H)-dione, or 3,7-dihydrobenzo[1,2-b:4,5-b′]dithiophene-2,6-dione.

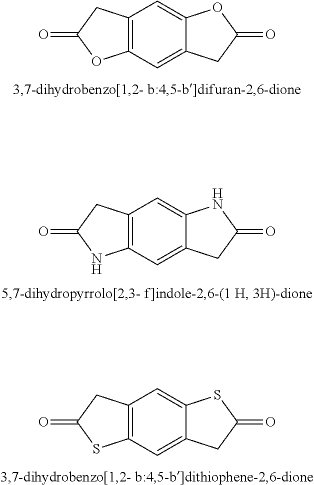 [SMILES: O=C1Cc2cc3c(cc2O1)CC(=O)O3 ; O=C1Cc2cc3c(cc2N1)CC(=O)N3 ; O=C1Cc2cc3c(cc2S1)CC(=O)S3]

In particular, the monomer is 3,7-dihydrobenzo[1,2-b:4,5-b′]difuran-2,6-dione (HBFDO). In such an embodiment, the n-type conducting polymer is poly(benzodifurandione) (PBFDO).

According to a particular embodiment, the catalyst may be Vitamin E. As commonly known in the art, Vitamin E is a group of eight fat soluble compounds that include four tocopherols and four tocotrienols, as illustrated below:

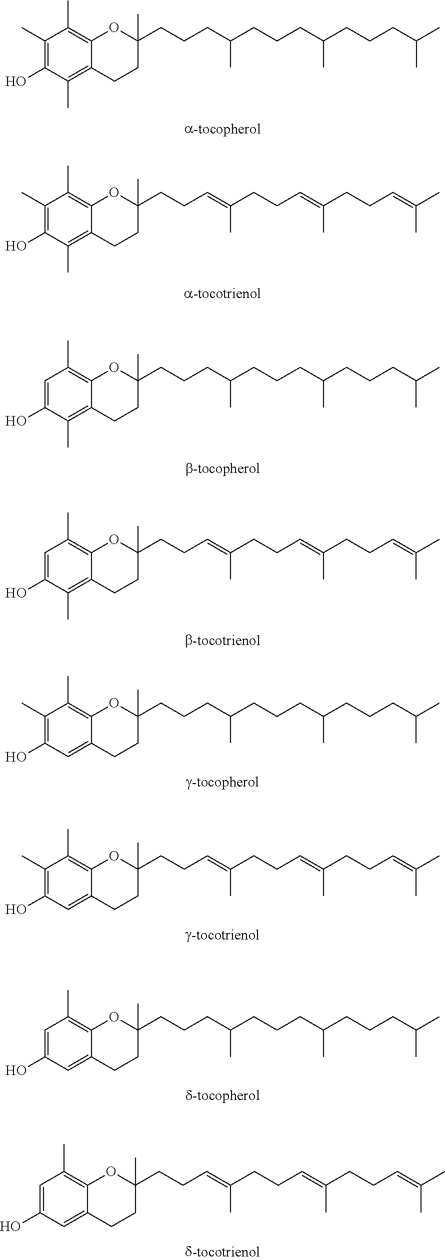

It should be noted that according to the method above, the term Vitamin E implies at least one of the species above. In other words, each of the species above may be present in its pure form in the reaction solution, or at least two of the species above may be present in any combination. Consequently, vitamin E may be selected from a group consisting of: α-tocopherol, β-tocopherol, γ-tocopherol, δ-tocopherol, α-tocotrienol, β-tocotrienol, γ-tocotrienol, δ-tocotrienol and mixtures thereof.

Vitamin E (generic term for tocopherols and tocotrienols) is a natural product with high redox activity. Vitamin E can be synthesized in plants that undergo photosynthesis, and it can be extracted in large quantities from plants. All vitamin E molecules have branched long hydrocarbon side chains, and they are natural oily substances with no crystallinity at room temperature. According to the method above, vitamin E may be used as catalyst to synthesize ink comprising n-type conducting polymer in one step or in one-pot without the need for post treatment, such as dialysis and solvent removal. Compared with the three-step method reported by Fei Huang, the method of the above achieves a great simplification.

It has been surprisingly shown that vitamin E itself has no catalytic effect, but the oxidized form of vitamin E does. In the presence of an oxidizing agent, vitamin E forms a benzoquinone derivative. According to the method above, in-situ oxidation initiates the polymerisation reaction. The method above thus offers the advantage of a simplified and cost-efficient method for manufacturing an ink comprising n-type conducting polymer compared to the methods known in the art. A great advantage of using Vitamin E as catalyst is its availability, low price and non-toxicity.

In a particular embodiment, the polar aprotic solvent is DMSO, and the oxidizing agent is hydrogen bromide (HBr). The HBr is volatile and does not affect film formation when the ink is printed.

Alternatively, the oxidizing agent is an ionic liquid comprising a cation and an anion. In such an embodiment, the method further comprises a step of:
3) electrolysing the reaction solution,
wherein the step 3) occurs simultaneously with or after step 1).

In particular, the step 3) may occur using a nickel cathode and a carbon anode under voltage in the range from 4 to 6 V for a period in the range from 10 to 60 min.

The cation in the ionic liquid may be selected from a group consisting of 1-ethyl-3-methylimidazolium (EMIM), 1-butyl-3-methylimidazolium (BMIM), 1-allyl-3-methylimidazolium (AMIM), 1-hexyl-3-methylimidazolium (HMIM), butyl-methyl pyrrolidinium (BMP), propyl-methyl pyrrolidinium (PMP), triethyl sulfonium and mixtures thereof. The structures of the cations are shown below.

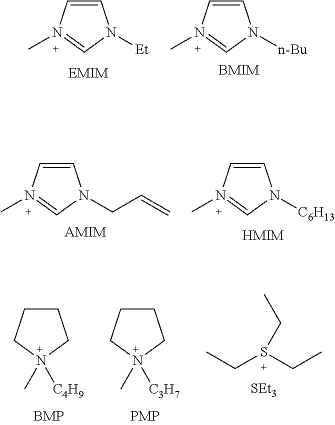

According to the method above, the anion may be selected from a group consisting of chloride (Cl⁻), bromide (Br⁻), iodide (I⁻), acetate (OAc), tetrafluoro borate (BF₄⁻), hexafluoro phosphate (PF₆⁻), bis-trifluoromethanesulfonimide (TFSI), trifluoromethanesulfonate (OTf), dicyanamide (DCA), hydrogen sulphate (HSO₄⁻), ethyl sulphate (ESO₄⁻), thiocyanate (SCN), tosylate (OTs), mesylate (OMs), tetrachloro aluminate (AlCl₄⁻), diethyl phosphate (DEP), dimethyl phosphate (DMP), lactate (La), L-alanine anion (APP) and mixtures thereof. The structures of the anions are illustrated below.

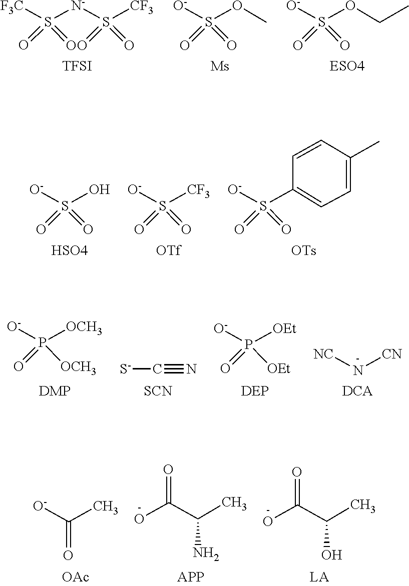

As mentioned above, the solvent system according to the method of the above comprises a polar aprotic solvent. The polar aprotic solvent may be dimethyl sulfoxide (DMSO), dimethyl formamide (DMF), dimethyl acetamide (DMA) or a combination thereof.

The ratio between the oxidizing agent and the vitamin E may be in the range from 0.1 to 100, preferably from 0.25 to 5, more preferably from 1 to 3.

The polymerisation reaction, i.e. step b) of the method above, may occur at a temperature from 20° C. to 150° C.

The method above may further comprise a step of:
4) removing the catalyst by extraction and recycling the catalyst.

The extraction may be performed using alkanes or ethers.

The general overview of the method above may be summarized as follows:

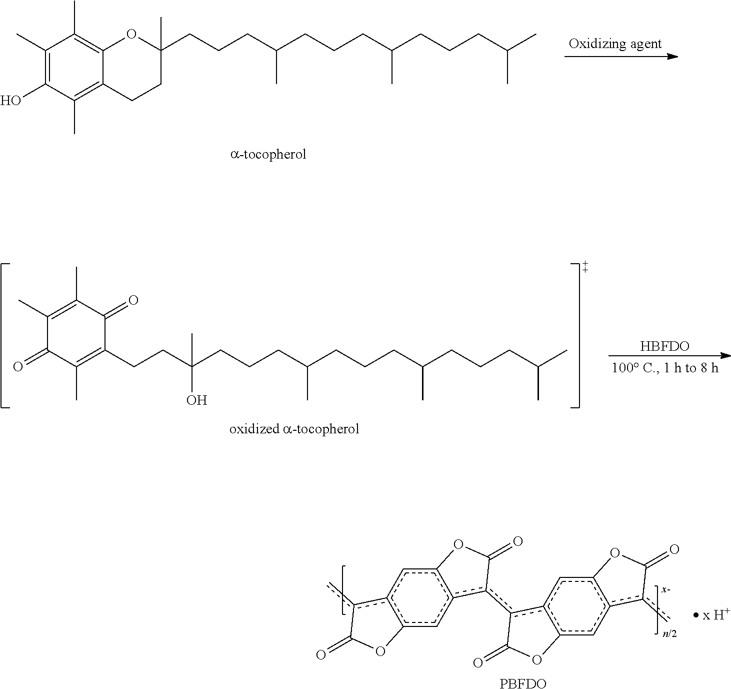

The ink comprising an n-type conducting polymer and manufactured by the method as described above may thus be used for manufacturing the polymer capacitor of the present invention. The n-type conducting ink may thus be spin-coated or drop-cast in air and ambient temperature, forming the film having thicknesses from 1 nm to 1 cm, more preferably from 10 nm to 10 μm. Such a film may exhibit electrical conductivity in the order of 1000 S/cm.

The anode may be tantalum (Ta) in the form of a high purity sintered tantalum powder as an anode with tantalum pentoxide (Ta₂O₅) as a dielectric.

Alternatively, the anode may be aluminium (Al) in the form of a high purity and electrochemically etched (roughened) aluminium foil with aluminium oxide (Al₂O₃) as the dielectric.

Alternatively, the anode may be niobium-II-oxide (NbO) with niobium pentoxide (Nb₂O₅) as a dielectric.

The polymer capacitor may be in the form of a rectangular SMD chip, usually moulded with a plastic case, available with sintered tantalum anode or with stacked aluminium anode foils.

Alternatively, the polymer capacitor may be in the form of a cylinder (only for Al).

The polymer capacitor may be encapsulated by e.g. a resin, such as an epoxy resin. Encapsulation prevents air contact and thus improved stability of the capacitor.

The present invention further refers to the method for manufacturing a polymer capacitor comprising an anode, a dielectric layer and a cathode, wherein said cathode comprises a solution-processed n-type conducting polymer having conductivity of at least 100 S/cm, preferably at least 500 S/cm, said method comprising the steps of:
a) providing an anode and a dielectric layer;
b) applying a cathode material on to said dielectric layer thus providing a polymer capacitor;
c) drying said polymer capacitor.

The method according to the present invention may further comprise the step of:
d) encapsulating the polymer capacitor.

Step d) may be performed by applying the encapsuling material, e.g. epoxy, onto the polymer capacitor, and curing the polymer capacitor at a temperature from 100° C. to 150° C. for a period of time from 1 h to 24 h. For instance, the encapsulating material may be cured at 120° C. overnight. The curing temperature is preferably kept at a level such that premature degradation of the polymer capacitor before capacitance testing is avoided.

The method according to the present invention may comprise the step of:
a′) anodization of an anode material thus providing an anode and a dielectric layer,
wherein step a′) occurs before step a).

### BRIEF DESCRIPTION OF THE DRAWINGS

Embodiments of the invention will now be described by way of example with reference to the accompanying drawings, of which:

FIG. 1 shows schematic view of the cross-sectional structure of a polymer capacitor according to the present invention;

FIG. 2 depicts different embodiments of the polymer capacitor according to the present invention;

FIGS. 3, 4a and 4b show perspective view and cross-section of the polymer capacitors depicted in FIG. 2;

FIG. 5 depicts conductivity change of the polymer electrode during annealing at 200° C. in nitrogen;

FIG. 6 illustrates conductivity change of the polymer electrode during annealing at 200° C. in air, wherein the capacitor comprises resin encapsulation;

FIG. 7 shows conductivity change of the polymer electrode during annealing at 300° C. in nitrogen;

FIG. 8 depicts conductivity change of the polymer ink that is stored in air;

FIGS. 9a-9c depict thermal stability of the solution processed n-type conducting polymer used in the polymer capacitor according to the present invention;

FIG. 10 shows capacitance retention of the polymer capacitors of the present invention compared to reference capacitors;

FIG. 11 illustrates thermal stability results in terms of capacitance of the capacitors according to the present invention compared to the reference capacitors;

FIG. 12 depicts a model of an ideal capacitor and an actual capacitor;

FIG. 13 illustrates impedance spectroscopy of the polymer capacitors according to the present invention compared to reference capacitors.

### DETAILED DESCRIPTION OF THE INVENTION

As mentioned above, the present invention provides a polymer capacitor comprising an anode, a dielectric layer and a cathode, wherein said cathode comprises a solution-processed n-type conducting polymer having conductivity of at least 100 S/cm, preferably at least 500 S/cm.

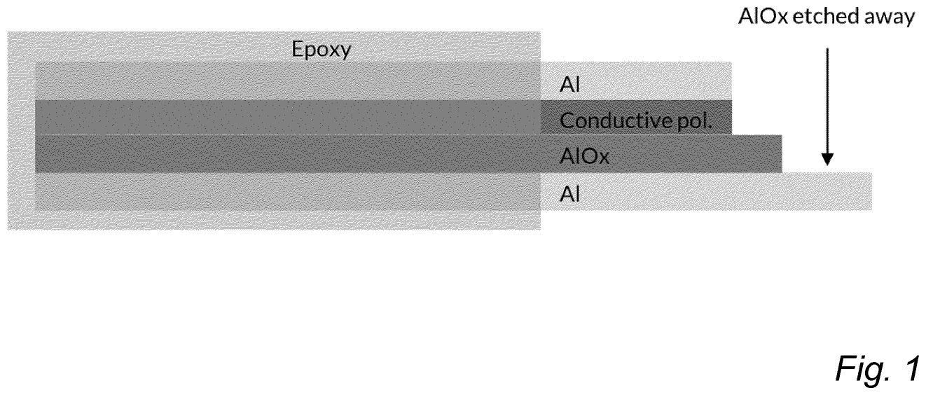

In the embodiment shown in FIG. 1, a schematic cross-section of a polymer capacitor according to the present invention is depicted. As may be seen, the polymer capacitor comprises an aluminium electrode (Al/Al₂O₃) comprising Al foil and an oxide layer. The n-type conducting polymer is spin-coated on the aluminium electrode. The top electrode is in the form of Al that may be applied by evaporation. The thickness of the top electrode may be from 50 to 500 nm. The polymer capacitor is epoxy encapsulated.

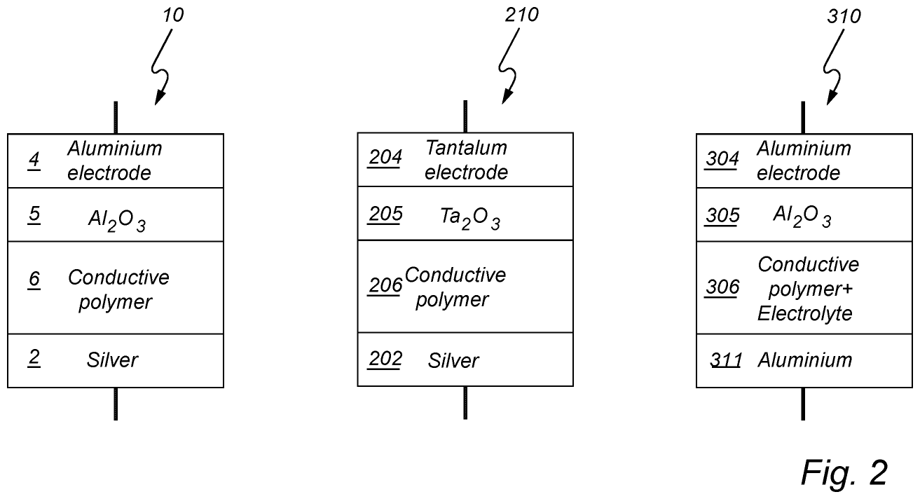

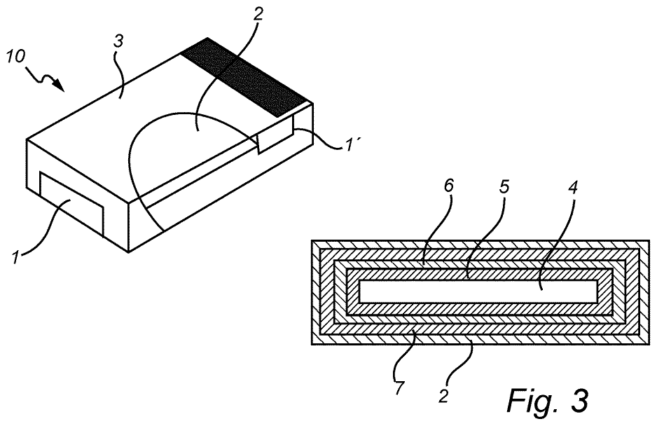

In the embodiments shown in FIG. 2, different types of polymer capacitors are shown from left to right: polymer aluminium electrolytic capacitor (Polymer Al-e-cap), polymer tantalum electrolytic capacitor (Polymer Ta-e-cap), and hybrid polymer capacitor (Hybrid polymer Al-e-cap). Further, FIG. 3 shows perspective and cross sectional view of the polymer Al-e-cap. Analogously, FIG. 4a shows perspective and cross sectional view of the Polymer Ta-e-cap, FIG. 4b shows perspective and cross sectional view of the Hybrid polymer Al-e-cap.

As may be seen in FIG. 3, a polymer capacitor 10 is depicted. The capacitor 10 comprises two terminals 1 and 1′, a silver paste layer 2 and an encapsulation layer 3 in the form of moulded resin. In the vertical cross-sectional view, aluminium foil 4 acts as anode, the aluminium oxide layer 5 acts as the dielectric, and the polymer layer 6 comprising the solution-processed n-type conducting polymer acts as cathode.

FIG. 4a depicts yet another embodiment of a rectangular capacitor 210 having tantalum anode 204, a tantalum pentoxide dielectric 205, a cathode layer 206 comprising solution-processed n-type conducting polymer, and a silver paste layer 202. As may be seen in FIG. 4a, the capacitor 210 comprises an encapsulation layer 203 in the form of moulded resin.

FIG. 4b illustrates a polymer capacitor 310 having a cylindric shape and comprising an aluminium anode 304, an aluminium oxide dielectric 305, a separation sheet 312 and a hybrid cathode 306 comprising solution-processed n-type conducting polymer and an electrolyte and impregnating the separation sheet 312.

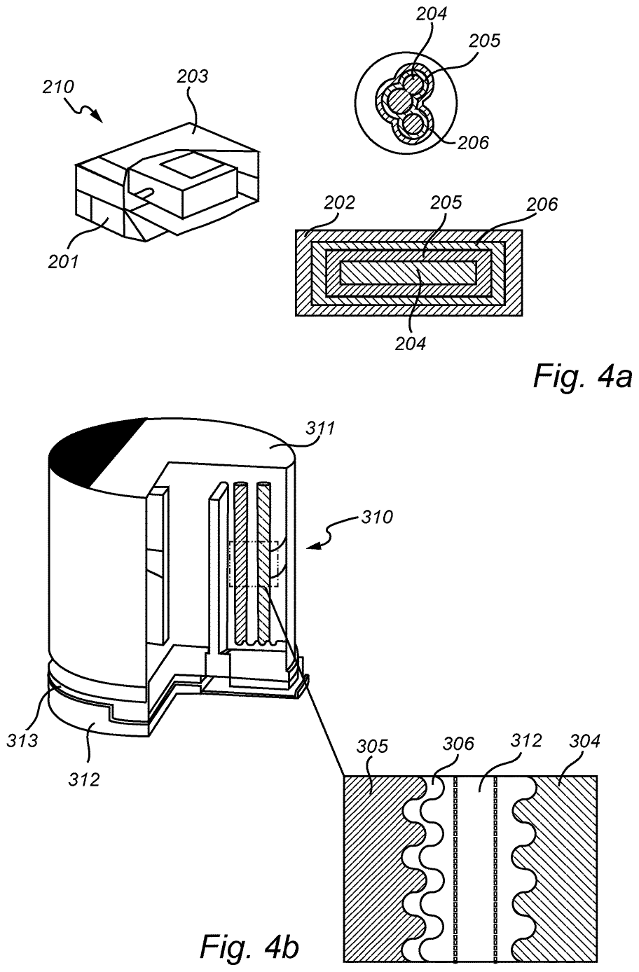

FIG. 5 depicts conductivity change of the polymer electrode during annealing at 200° C. in nitrogen. As may be seen, the capacitor of the present invention shows excellent thermal stability with almost unchanged conductivity even after 8 h.

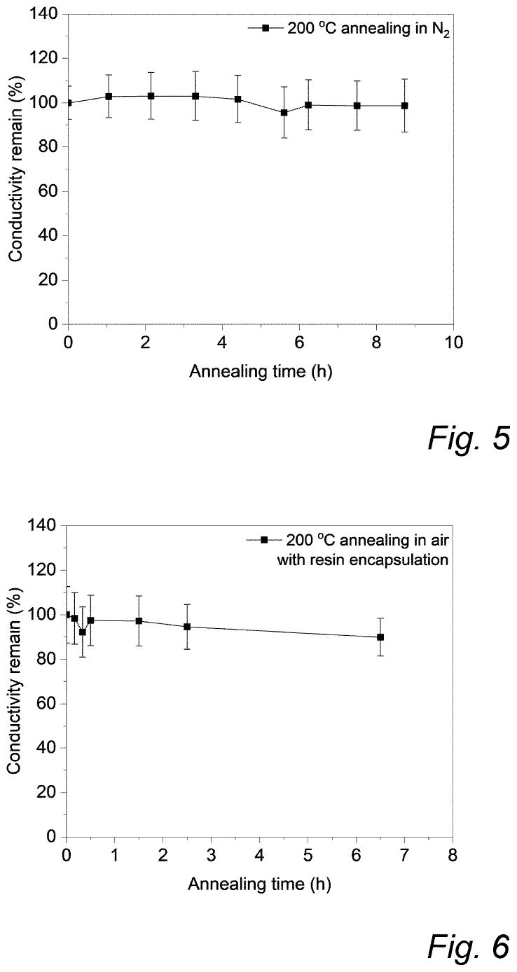

The capacitor comprising resin encapsulation may be annealed in air with good results. As may be seen in FIG. 6, conductivity dropped only insignificantly during annealing at 200° C. in air after 6 h.

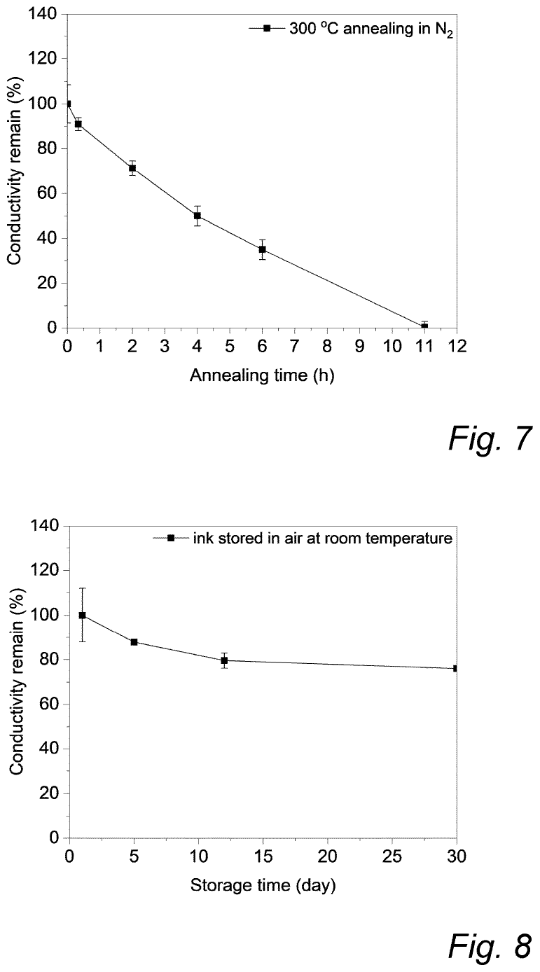

When the annealing temperature was elevated 300° C., thermal stability was compromised, and conductivity dropped significantly already after 2 h in nitrogen atmosphere (FIG. 7).

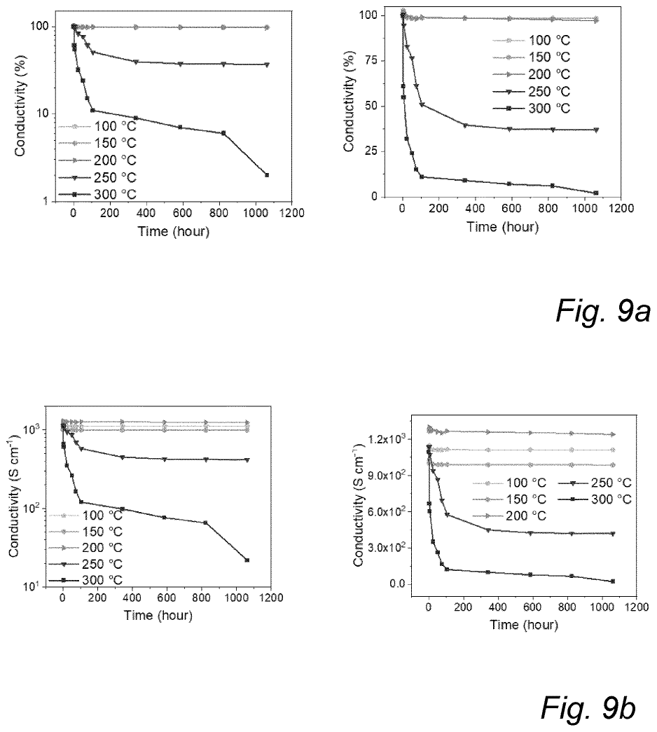

The ink comprising solution-processed n-type conducting polymer used in the polymer capacitor of the present invention showed excellent storage stability, as may be seen in FIG. 8.

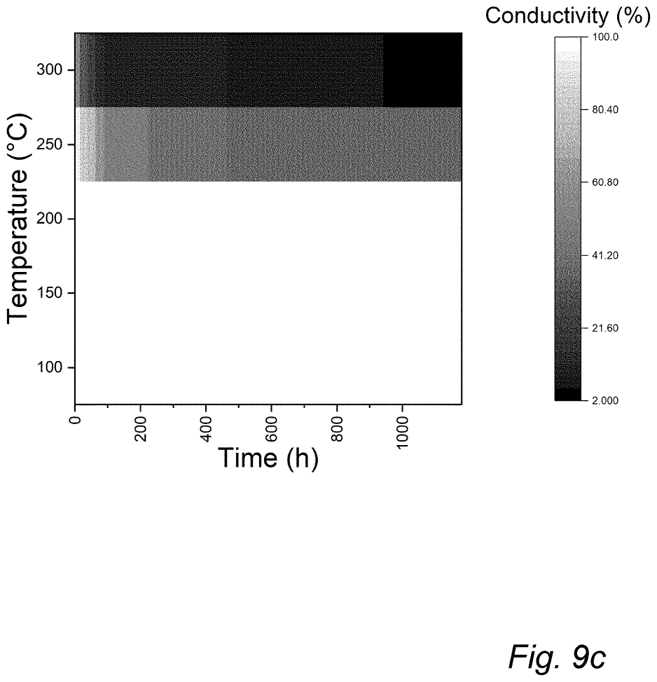

FIGS. 9a and 9b illustrates thermal stability of the n-type conducting polymer used in the polymer capacitor of the present invention, i.e. poly(benzodifurandione) (PBFDO). As may be seen, PBFDO shows remarkable thermal stability with virtually no drop in conductivity up to 200° C. The solution-processed n-type conducting polymer may thus be heat resistant up to 225° C., as confirmed in FIG. 9c. By the term “heat resistant” is meant that the solution-processed n-type conducting polymer keeps its conductivity in a film up to 225° C.

Polymer capacitors according to the present invention, as well as reference capacitors, were manufactured as follows. Commercial anodized aluminium foil (ANOFOL, H18) of 50 μm thickness with an oxide layer of 4 μm was obtained from Steinert GmbH.

Reference samples were obtained by using PEDOT:PSS as conducting polymer. PEDOT:PSS (Clevios PH 1000 with 5 wt % ethylene glycol added as a secondary dopant) was spin coated onto anodized aluminum (1500 rpm for 30 seconds) and dried on a hotplate (110° C.). The PEDOT:PSS does not seem to penetrate the oxide layer, as the resistance measured by multimeter was in the range of 100 kOhm (compared to >10 MOhm when measuring directly on oxide, or <1 Ohm when probing non-anodized foil).

The resistance and capacitance of the produced films were tested using multimeter and LCR meter. The resistance of the PEDOT:PSS film was in the order of 400 Ohm/sq. The capacitance of the structure was in the order of 20 nF. Probing only the anodized aluminum gave a capacitance in the order of 20 pF.

Inventive samples were obtained by using PBFDO as n-type conducting polymer. Spin coating was performed at 500/1000 rpm for 3 min, followed by 3000 rpm for 30 s.

Drying was performed on a hot plate at 40° C. for the inventive (n-ink) samples, and at 110° C. for the reference (PEDOT:PSS) samples. The top electrode having thickness of 100 nm was obtained by aluminum evaporation. The samples did not get shorted (i.e. conductive polymer did not penetrate the oxide) during the processing.

Stray material from spin coating and evaporation was removed from the edges of the samples by applying capton tape and removing the tape. This prevents shorts caused by evaporated aluminum on the edge of the sample which does not have a thick oxide layer.

One end of each strip was etched in 0.5 M NaOH to remove the oxide and make an electrical contact to the bottom Al electrode.

Three inventive and three reference samples were put into molds to cast the epoxy. Two inventive and two reference samples were put in the oven without encapsulation.

The epoxy (COTRONICS Duralco 4460) was cured at 120° C. overnight. The curing temperature was kept below 125° C. to prevent any premature degradation of the polymer capacitor before capacitance testing.

Cables and crocodile connectors were used to connect to the samples. The cables are qualified to work up to 200° C. and comprise aluminum shielding. All the shieldings are connected to each other and to ground. Nine cables were used, wherein eight cables were used for the four caps, and one was for used for ground or shielding.

The LCR meter was calibrated to the new setup and high-temperature cables. Prior to epoxy encapsulation, all samples were measured using both LCR meter and impedance spectroscopy on potentiostat at room temperature.

The capacitors were tested at 125, 150, and 200° C. The LCR values and impedance values were monitored twice a day at 200° C.

The capacitance results are summarized in Table 1, showing measured and normalized capacitance for each sample before and after high-temperature testing.

TABLE 1

| | Initial capacitance | Final capacitance | Capacitance |
|---|---|---|---|
| Sample | (nF/cm2) | (nF/cm2) | reduction (%) |
| Ref 1 | 4.96 | 1.13 | 77 |
| Ref 2 | 2.71 | 1.23 | 55 |
| Inventive 1 | 1.62 | 1.48 | 9 |
| Inventive 2 | 1.68 | 1.32 | 21 |

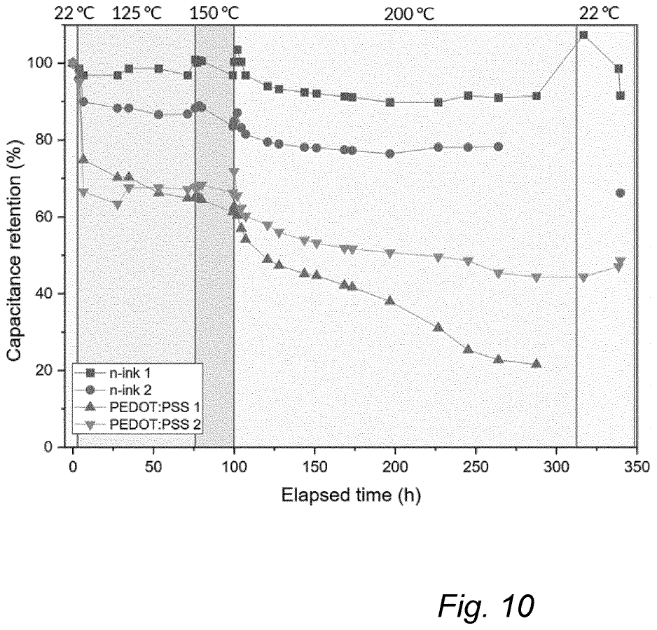

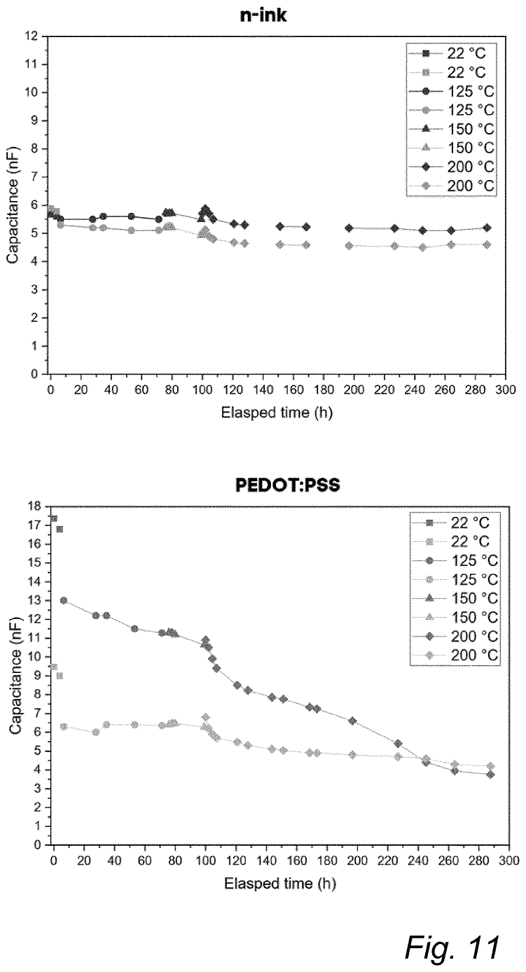

FIG. 10 illustrates capacitance retention if the inventive and reference samples as a function of time and temperature. As may be seen, reference samples comprising PEDOT:PSS exhibit continuously drop in capacitance with increasing temperature. On the other hand, inventive samples comprising n-ink seem to have stabilized after an initial drop. FIG. 11 illustrates capacitance values of the samples.

Impedance spectroscopy was performed using an Ivium potentiostat at a frequency range from 100 to 100000 Hz and voltage of 10 mV AC.

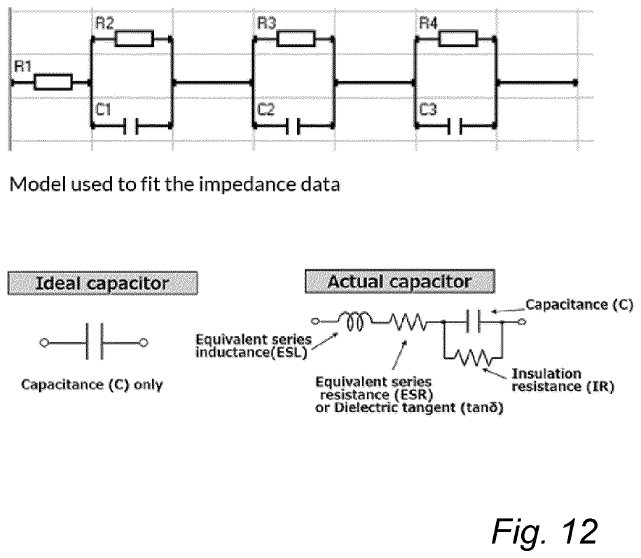

The impedance data was modelled using an equivalent circuit shown in FIG. 12. The model suggests three distinct capacitive layers/processes. The three components are suggested to be The Al/AlOₓ/CP interface, CP/Al double layer (due to mobile ions) and Al/AlOₓ/Metal at the contact between crocodile clips and the sample.

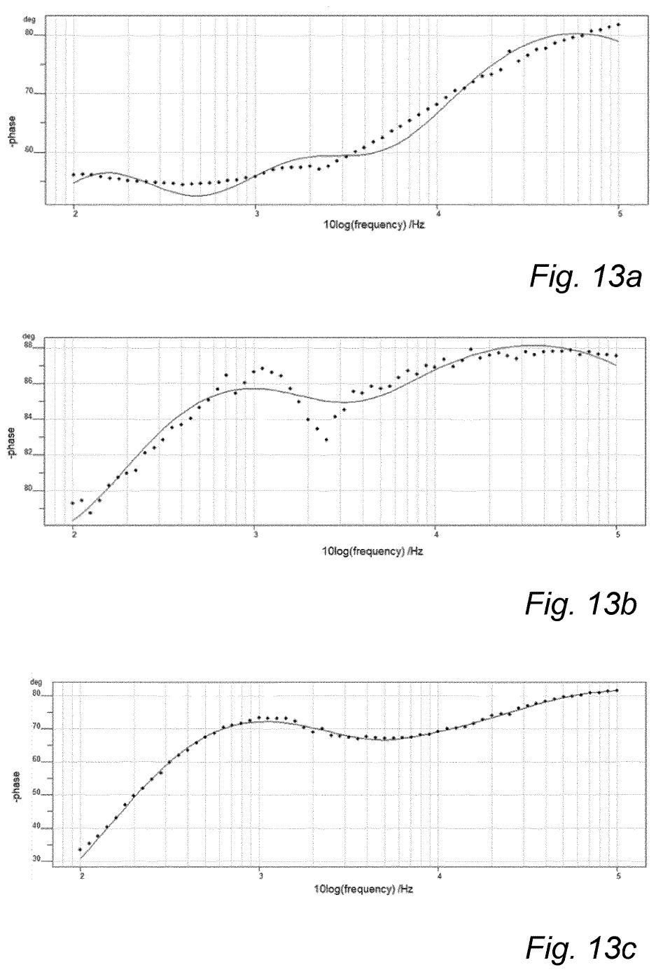

The phase angle is depicted in FIG. 13, and describes which processes are dominating at different frequencies. An ideal capacitor should have a phase angle of −90° over all frequencies.

For both n-ink and PEDOT:PSS capacitors, a small phase angle which goes towards −90° at higher frequencies is initially seen. The behaviour is more pronounced for the PEDOT:PSS samples and is believed to be linked to ionic resistive (dissipative) processes.

For the n-ink samples, the phase angle improves after encapsulation and heating, while the PEDOT:PSS sample remains unchanged. The reason for such a difference is probably ionic PSS-rich phase of PEDOT:PSS, which makes it a less ideal material for polymer capacitors.

The samples were measured by LCR meter and impedance spectroscopy (potentiostat) at RT (ambient), 125° C. (vacuum), 150° C. (vacuum), 200° C. (vacuum), RT (vacuum), RT (ambient).

FIG. 13a illustrates the phase angle of an inventive sample before encapsulation, FIG. 13b shows the phase angle of the inventive sample at 200° C., and FIG. 13c depicts the phase angle of the reference sample at 200° C. LCR meter data shows a much faster capacitance degradation in the PEDOT:PSS samples compared to the N-ink samples, thus confirming that the n-ink capacitors are more stable at high temperature. Further, impedance spectroscopy data shows a more ideal capacitive behaviour of the n-ink capacitors compared to the PEDOT:PSS capacitors.

Although the present invention has been described with reference to various embodiments, those skilled in the art will recognize that changes may be made without departing from the scope of the invention. It is intended that the detailed description be regarded as illustrative and that the appended claims including all the equivalents are intended to define the scope of the invention.

1. A polymer capacitor comprising an anode, a dielectric layer, and a cathode, wherein said cathode comprises a solution-processed n-type conducting polymer having conductivity of at least 100 S/cm.

2. The polymer capacitor according to claim 1, wherein said solution-processed n-type conducting polymer is heat resistant up to 225° C.

3. The polymer capacitor according to claim 1, wherein said solution-processed n-type conducting polymer has a work function of at least 4.7 eV.

4. The polymer capacitor according to claim 1, wherein said solution-processed n-type conducting polymer is side-chain free.

5. The polymer capacitor according to claim 1, wherein said anode is tantalum (Ta), and said dielectric layer is tantalum oxide (Ta₂O₅).

6. The polymer capacitor according to claim 1, wherein said anode is niobium (II) oxide (NbO), and said dielectric layer is niobium (V) oxide (Nb₂O₅).

7. The polymer capacitor according to claim 1, wherein said anode is aluminum (Al), and said dielectric layer is aluminum oxide (Al₂O₃).

8. The polymer capacitor according to claim 1, wherein the solution-processed n-type conducting polymer is poly(benzodifurandione) (PBFDO), poly[(2,2′-(2,5-dihydroxy-1,4-phenylene)diacetic acid)-co-3,7-dihydrobenzo[1,2-b:4,5-b′]difuran-2,6-dione] (PDADF), poly[(2,2′-(2,5-dihydroxy-1,4-phenylene)diacetic acid) (PDADF-P), or a mixture thereof.

9. The polymer capacitor according to claim 1, wherein said polymer capacitor is in the form of a rectangular SMD chip.

10. The polymer capacitor according to claim 1, wherein said polymer capacitor is in the form of a cylinder.

11. The polymer capacitor according to claim 1, wherein said polymer capacitor is encapsulated.

12. A method for manufacturing a polymer capacitor comprising an anode, a dielectric layer, and a cathode, wherein said cathode comprises a solution-processed n-type conducting polymer having conductivity of at least 100 S/cm, said method comprising the steps of:
a) providing an anode and a dielectric layer;
b) applying a cathode material on to said dielectric layer thus providing a polymer capacitor; and
c) drying said polymer capacitor.

13. The method according to claim 12, said method further comprising the step of:
d) encapsulating said polymer capacitor.

14. The method according to claim 12, said method further comprising the step of:
a′) anodization of an anode material thus providing an anode and a dielectric layer,
wherein step a′) occurs before step a).

15. The polymer capacitor of claim 1, wherein the solution-processed n-type conducting polymer has a conductivity of at least 500 S/cm.

16. The polymer capacitor of claim 3, wherein the solution-processed n-type conducting polymer has a work function of at least 4.9 eV.

17. The method of claim 12, wherein the solution-processed n-type conducting polymer having conductivity of at least 500 S/cm.
